(19) United States
(12) Patent Application Publication
(10) Pub. No.: US 2024/0274843 A1
(43) Pub. Date: Aug. 15, 2024

(54) OXIDIZING GAS SUPPLY SYSTEM, AND FUEL CELL ELECTRIC VEHICLE

(71) Applicant: MITSUBISHI HEAVY INDUSTRIES ENGINE & TURBOCHARGER, LTD., Sagamihara-shi, Kanagawa (JP)

(72) Inventors: Yusuke YASHIRO, Tokyo (JP); Yuki YAMADA, Tokyo (JP); Kazuki WATANABE, Tokyo (JP); Yasuaki JINNAI, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 18/567,401

(22) PCT Filed: Sep. 13, 2021
(86) PCT No.: PCT/JP2021/033578

§ 371 Date: Dec. 6, 2023

(51) Int. Cl. H01M 8/04111; H01M 8/04029; H01M 8/04082; H01M 8/0438; H01M 8/04746

(52) U.S. Cl. CPC H01M 8/04111; H01M 8/04029; H01M 8/04201; H01M 8/04425; H01M 8/04753; H01M 8/04776

(57) ABSTRACT

This oxidizing gas supply system for supplying a fuel cell with an oxidizing gas that has been compressed by a compressor comprises: a compressor having a compressor impeller; an oxidizing gas supply line for supplying the oxidizing gas that has passed through the compressor impeller to the fuel cell; an oxidizing gas introduction line for introducing the oxidizing gas to the compressor impeller; an oxidizing gas recirculation line which branches from the oxidizing gas supply line and is connected to the oxidizing gas introduction line; and a flow rate adjusting valve configured to be capable of adjusting the flow rate of the oxidizing gas passing through the oxidizing gas recirculation line.

### TECHNICAL FIELD

The present disclosure relates to an oxidizing gas supply system for supplying an oxidizing gas compressed by a compressor to a fuel cell, and a fuel cell electric vehicle including the oxidizing gas supply system.

### BACKGROUND ART

A fuel cell electric vehicle (FCEV) is configured to travel in such a manner that a traveling motor is rotated by using electric energy generated by a chemical reaction between a fuel gas (hydrogen) and an oxidizing gas (oxygen) in a fuel cell. The hydrogen supplied to the fuel cell is stored in a hydrogen tank mounted in the fuel cell electric vehicle. As the oxygen supplied to the fuel cell, oxygen in air is used. In some cases, an electric compressor may be provided in an oxygen supply system for supplying the oxygen to the fuel cell so that a large amount of the air can be fed into the fuel cell or a pressure inside the fuel cell can be maintained. The electric compressor controls and changes a rotation speed of the electric compressor to be capable of providing a required power generation amount, that is, a reaction amount between the hydrogen and the oxygen, in accordance with a state of the fuel cell electric vehicle.

Since a portion of electric power generated by the electric compressor is used, a turbine is provided on an air discharge side of the fuel cell to improve efficiency of a power generation system in the fuel cell electric vehicle (PTL 1), or a turbocharger is provided (PTL 2).

### CITATION LIST

### Patent Literature

[PTL 1] Japanese Unexamined Patent Application Publication No. 2005-310429
[PTL 2] PCT Japanese Translation Patent Publication No. 2005-507136

### SUMMARY OF INVENTION

### Technical Problem

Incidentally, in the electric compressor, it is known that when a flow rate on an outlet side is lower compared to a pressure increase amount on the outlet side, a vibration phenomenon called surging occurs, thereby causing noise or damage to the electric compressor. In addition, it is known that there exists a minimum flow rate (surge region/surge line) for preventing the surging from occurring, in accordance with the pressure increase amount (pressure ratio) on the outlet side.

In the fuel cell electric vehicle, it is necessary to increase a pressure on the outlet side of the electric compressor to maintain an air system pressure inside the fuel cell. However, the flow rate on the outlet side is not required to be that high. Therefore, in order to suppress motor electric power consumption of the electric compressor as a result, the fuel cell electric vehicle is operated at a pressure/flow rate balance close to that in the surge region.

When a rotation speed of the electric compressor cannot be increased due to mechanical loss reduction, it is necessary to use a large electric compressor to satisfy an air supply requirement for the fuel cell. However, as a size of the electric compressor increases, the surge line becomes closer to a high flow rate side. Consequently, the surging tends to more easily occur.

In view of the above-described circumstances, an object of at least one embodiment of the present disclosure is to provide an oxidizing gas supply system which can suppress surging in a compressor that supplies an oxidizing gas to a fuel cell, and a fuel cell electric vehicle including the oxidizing gas supply system.

### Solution to Problem

According to an embodiment of the present disclosure, there is provided an oxidizing gas supply system for supplying an oxidizing gas compressed by a compressor to a fuel cell.

The oxidizing gas supply system includes a compressor including a compressor impeller, an oxidizing gas supply line for supplying the oxidizing gas passing through the compressor impeller to the fuel cell, an oxidizing gas introduction line for introducing the oxidizing gas into the compressor impeller, an oxidizing gas recirculation line branching from the oxidizing gas supply line and connected to the oxidizing gas introduction line, and a flow rate adjusting valve configured to adjust a flow rate of the oxidizing gas passing through the oxidizing gas recirculation line.

According to another embodiment of the present disclosure, there is provided a fuel cell electric vehicle including the oxidizing gas supply system.

The fuel cell electric vehicle is configured to travel by using electric power generated by the fuel cell.

### Advantageous Effects of Invention

According to at least one embodiment of the present disclosure, there are provided an oxidizing gas supply system which can suppress surging in a compressor that supplies an oxidizing gas to a fuel cell, and a fuel cell electric vehicle including the oxidizing gas supply system.

### BRIEF DESCRIPTION OF DRAWINGS

FIG. 1 is a schematic configuration diagram schematically illustrating a configuration of a fuel cell electric vehicle according to an embodiment of the present disclosure.

FIG. 2 is a view for describing a function of a control device according to the embodiment of the present disclosure.

FIG. 3 is a flowchart illustrating an example of control including first opening degree increasing control of the control device according to the embodiment of the present disclosure.

FIG. 4 is a flowchart illustrating an example of control including rapid opening degree increasing control of the control device according to the embodiment of the present disclosure.

FIG. 5 is a view for describing a change in an operating point of a compressor when a flow rate of an oxidizing gas supplied to a fuel cell is changed to a low flow rate.

FIG. 6 is a flowchart illustrating an example of control including second opening degree increasing control of the control device according to the embodiment of the present disclosure.

FIG. 7 is a view for describing second opening degree increasing control and second opening degree decreasing control.

FIG. 8 is a view for describing a heat exchanger of an oxidizing gas supply system according to the embodiment of the present disclosure.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as the quadrangular shape and the cylindrical shape in a geometrically strict sense, but also represent shapes including an uneven portion or a chamfered portion within a range where the same effect can be obtained.

Meanwhile, expressions of “being provided with”, “including”, or “having” one component are not exclusive expressions excluding existence of other components.

The same reference numerals may be assigned to the same configurations, and description thereof may be omitted.

### (Fuel Cell Electric Vehicle)

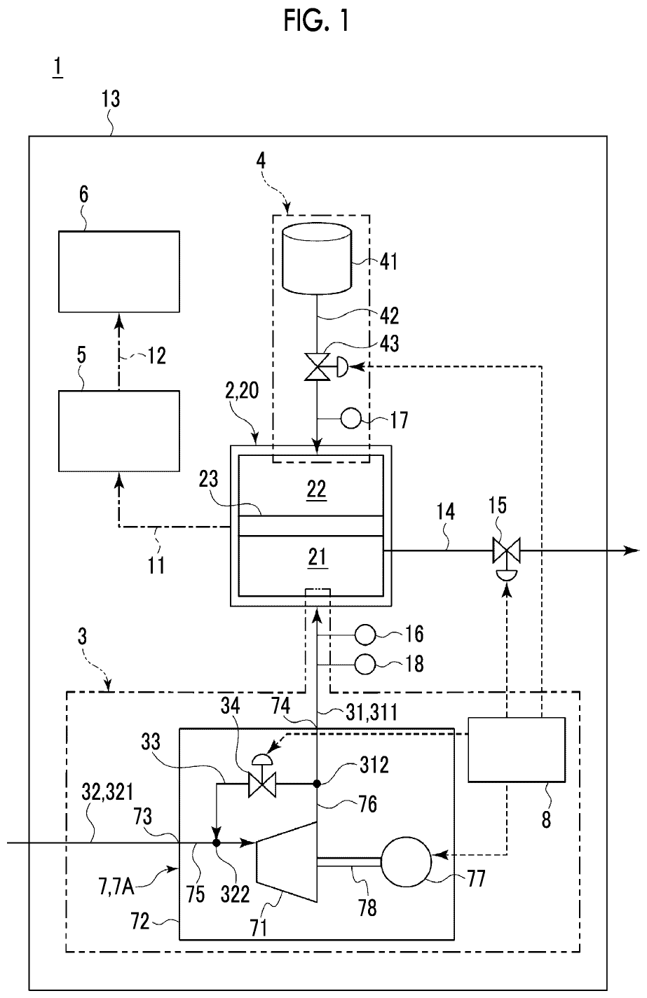

FIG. 1 is a schematic configuration diagram schematically illustrating a configuration of a fuel cell electric vehicle 1 according to an embodiment of the present disclosure. The fuel cell electric vehicle 1 according to some embodiments is an electric vehicle configured to travel by using electric power generated by a fuel cell (FC) 2. In the fuel cell 2, a fuel gas (hydrogen gas in the illustrated example) serving as a negative electrode active material and an oxidizing gas (oxygen in the air in the illustrated example) serving as a positive electrode active material are supplied (replenished) in a normal temperature or a high temperature environment. The fuel cell 2 is configured to generate electricity through an electrochemical reaction between the supplied fuel gas and the supplied oxidizing gas.

As illustrated in FIG. 1, the fuel cell electric vehicle 1 includes the fuel cell 2, an oxidizing gas supply system 3 for supplying the oxidizing gas to the fuel cell 2, a fuel gas supply system 4 for supplying the fuel gas to the fuel cell 2, a driving battery (secondary battery) 5 configured to be charged with the electric power generated by the fuel cell 2, and a traveling motor 6 configured to be driven by the electric power generated by the fuel cell 2.

### (Fuel Cell)

In the illustrated embodiment, the fuel gas supplied to the fuel cell 2 is made of the hydrogen gas, and the oxidizing gas supplied to the fuel cell 2 is made of oxygen in air. As illustrated in FIG. 1, the fuel cell 2 includes at least one power generation cell 20 including an air electrode 21 which is an electron receiving side electrode (cathode), a fuel electrode 22 which is an electron emitting side electrode (anode), and an electrolyte film 23 interposed between the air electrode 21 and the fuel electrode 22 so that the air electrode 21 and the fuel electrode 22 are separated. The fuel cell 2 may have a configuration in which a plurality of the power generation cells 20 and a separator interposed between the plurality of power generation cells 20 are laminated. In the illustrated embodiment, the electrolyte film 23 is made of a solid polymer electrolyte film.

In the fuel cell 2, oxygen-containing air is supplied to a catalyst layer on the air electrode 21 side of each of the plurality of power generation cells 20 by the oxidizing gas supply system 3. In addition, in the fuel cell 2, the hydrogen gas is supplied to a catalyst layer on the fuel electrode 22 side of each of the plurality of power generation cells 20 by the fuel gas supply system 4.

In the fuel cell 2, the oxygen-containing air is supplied to the air electrode 21, and the hydrogen gas is supplied to the fuel electrode 22. In this manner, a chemical reaction as illustrated below occurs. Therefore, electric energy can be extracted as an electromotive force generated between electrodes (between the air electrode 21 and the fuel electrode 22).
Fuel electrode 22 (anode): H_{2→2}H++2e−
Air electrode 21 (cathode): ½O₂+2H++2e—→H₂O

### (Driving Battery and Traveling Motor)

An output of the fuel cell 2 is connected to an input of the driving battery 5 via a first connection cable 11. The output of the driving battery 5 is connected to an input of the traveling motor 6 via a second connection cable 12. The electric power generated by the fuel cell 2 is supplied to the driving battery 5 via the first connection cable 11, and the driving battery 5 stores (is charged with) the supplied electric power. The electric power used for charging the driving battery 5 is mainly supplied to the traveling motor 6, and the traveling motor 6 is driven by the electric power supplied from the driving battery 5. The driving battery 5 may be any of a lithium ion battery, a nickel-cadmium battery, and a nickel-hydrogen battery, and is not particularly limited.

The output of the driving battery 5 is also connected to an input of an electric device mounted in the fuel cell electric vehicle 1. The electric power used for charging the driving battery 5 is supplied to the electric device mounted in the fuel cell electric vehicle 1. The output of the fuel cell 2 may be directly connected to an input of the traveling motor 6 or of the electric device mounted in the fuel cell electric vehicle 1.

As illustrated in FIG. 1, the fuel cell electric vehicle 1 further includes a vehicle body 13 in which each of the fuel cell 2, the oxidizing gas supply system 3, the fuel gas supply system 4, the driving battery 5, and the traveling motor 6 is mounted. The fuel cell electric vehicle 1 further includes a plurality of wheels (front wheels and rear wheels) (not illustrated) which are rotatably supported with respect to the vehicle body 13. The traveling motor 6 is connected to at least one of the front wheels and the rear wheels to be capable of transmitting a driving force (rotational force). As the traveling motor 6 is driven, the fuel cell electric vehicle 1 travels by rotating the front wheels and the rear wheels to which the driving force is transmitted from the traveling motor 6.

### (Oxidizing Gas Supply System)

The oxidizing gas supply system 3 is used to supply the oxygen-containing air (oxidizing gas) compressed by a compressor 7 to the air electrode 21 of the fuel cell 2. As illustrated in FIG. 1, the oxidizing gas supply system 3 includes at least the compressor 7 including a compressor impeller 71, an oxidizing gas supply line 31 for supplying the oxygen-containing air passing through the compressor impeller 71 to the air electrode 21 (catalyst layer on the air electrode 21 side) of the fuel cell 2, and an oxidizing gas introduction line 32 for introducing the oxygen-containing air into the compressor impeller 71 of the compressor 7.

The compressor 7 further includes a compressor cover 72 that rotatably accommodates the compressor impeller 71. An introduction port 73 for introducing the oxygen-containing air from the outside of the compressor cover 72, and an discharge port 74 for discharging the oxygen-containing air passing through the compressor impeller 71 to the outside of the compressor cover 72 are formed in the compressor cover 72. An oxidizing gas introduction path 75 for guiding the oxygen-containing air introduced into the compressor cover 72 from the introduction port 73 to the compressor impeller 71, and an oxidizing gas discharge path 76 for guiding the oxygen-containing air passing through the compressor impeller 71 from the discharge port 74 to the outside of the compressor cover 72 are formed inside the compressor cover 72.

The oxidizing gas introduction line 32 includes at least the oxidizing gas introduction path 75. As illustrated in FIG. 1, the oxidizing gas introduction line 32 may further include an oxidizing gas introduction pipe 321 whose one side is connected to the introduction port 73 of the compressor cover 72 and whose other side is open. In this case, the oxygen-containing air in the atmosphere is introduced into the compressor impeller 71 via the oxidizing gas introduction pipe 321 and the oxidizing gas introduction path 75.

The oxidizing gas introduction line 32 may further include an oxidizing gas storage device (for example, an oxidizing gas storage tank) (not illustrated) configured to store the compressed oxidizing gas (for example, oxygen), and the other side of the oxidizing gas introduction pipe 321 may be connected to the oxidizing gas storage device. In this case, the oxidizing gas stored in the oxidizing gas storage device is introduced into the compressor impeller 71 via the oxidizing gas introduction pipe 321 and the oxidizing gas introduction path 75.

The oxidizing gas supply line 31 includes an oxidizing gas discharge path 76 and an oxidizing gas supply pipe 311. One side of the oxidizing gas supply pipe 311 is connected to the discharge port 74 of the compressor cover 72, and the other side is connected to the air electrode 21 of the fuel cell 2. The oxidizing gas supply line 31 is configured to guide the oxygen-containing air compressed by the compressor impeller 71 to the air electrode 21 (catalyst layer on the air electrode 21 side) of the fuel cell 2 via the oxidizing gas discharge path 76 and the oxidizing gas supply pipe 311.

The oxygen-containing air is drawn into the compressor cover 72 from the introduction port 73 by a suction force generated by driving the compressor 7 and rotating the compressor impeller 71. The oxygen-containing air drawn into the compressor cover 72 is guided to the compressor impeller 71 via the oxidizing gas introduction path 75, and is compressed by the compressor impeller 71. The oxygen-containing air compressed by the compressor impeller 71 is supplied to the air electrode 21 (catalyst layer on the air electrode 21 side) of the fuel cell 2 via the oxidizing gas supply line 31.

In the illustrated embodiment, the compressor 7 includes an electric compressor 7A configured so that the electric power is supplied from the driving battery 5 and the compressor impeller 71 is rotated by the electric power supplied from the driving battery 5. The electric compressor 7A further includes an electric motor (electric motor) 77 that generates a rotational force for rotating the compressor impeller 71 via the electric power supplied from the driving battery 5, and a rotary shaft 78 mechanically connected to the electric motor 77 and to the compressor impeller 71 and transmitting the rotational force from the electric motor 77 to the compressor impeller 71. In some other embodiments, instead of the electric compressor 7A, the oxidizing gas supply system 3 may include a turbocharger including the compressor impeller 71, a turbine blade rotated by energy of an exhaust gas (steam) discharged from the fuel cell 2, and a rotary shaft for mechanically connecting the compressor impeller 71 and the turbine blade.

### (Fuel Gas Supply System)

The fuel gas supply system 4 is used to supply the hydrogen gas (fuel gas) to the fuel electrode 22 of the fuel cell 2. As illustrated in FIG. 1, the fuel gas supply system 4 includes a fuel gas storage device (for example, a hydrogen gas storage tank) 41 configured to store the hydrogen gas, a fuel gas supply line 42 for supplying the hydrogen gas to the fuel electrode 22 (catalyst layer on the fuel electrode 22 side) of the fuel cell 2 from the fuel gas storage device 41, and a fuel gas flow rate adjusting valve 43 configured to adjust a flow rate of the hydrogen gas passing through the fuel gas supply line 42. One side of the fuel gas supply line 42 is connected to the fuel gas storage device 41, and the other side is connected to the fuel electrode 22 of the fuel cell 2.

The hydrogen gas is stored in the fuel gas storage device 41 in a compressed state, and when the fuel gas flow rate adjusting valve 43 is fully closed, a pressure on an upstream side (side where the fuel gas storage device 41 is located) of the fuel gas flow rate adjusting valve 43 of the fuel gas supply line 42 becomes higher than a pressure on a downstream side (side where the fuel electrode 22 of the fuel cell 2 is located) of the fuel gas flow rate adjusting valve 43 of the fuel gas supply line 42. When the fuel gas flow rate adjusting valve 43 is opened due to a pressure difference between the upstream side and the downstream side of the fuel gas flow rate adjusting valve 43 of the fuel gas supply line 42, the hydrogen gas flows from the upstream side to the downstream side of the fuel gas supply line 42, and is supplied to the fuel electrode 22 of the fuel cell 2.

### (Oxidizing Gas Recirculation Line and Oxidizing Gas Flow Rate Adjusting Valve)

As illustrated in FIG. 1, the oxidizing gas supply system 3 further includes an oxidizing gas recirculation line 33 branching from the oxidizing gas supply line 31 and connected to the oxidizing gas introduction line 32, and an oxidizing gas flow rate adjusting valve (flow rate adjusting valve) 34 configured to adjust the flow rate of the oxygen-containing air passing through the oxidizing gas recirculation line 33. One side of the oxidizing gas recirculation line 33 is connected to a branching portion 312 of the oxidizing gas supply line 31, and the other side is connected to a merging portion 322 of the oxidizing gas introduction line 32.

The oxygen-containing air compressed by the compressor impeller 71 flows through the oxidizing gas supply line 31. Therefore, when the oxidizing gas flow rate adjusting valve 34 is fully closed, the pressure of the oxidizing gas supply line 31 located on the downstream side of the compressor impeller 71 becomes higher than the pressure of the oxidizing gas introduction line 32 located on the upstream side of the compressor impeller 71. When the oxidizing gas flow rate adjusting valve 34 is opened due to a pressure difference between the oxidizing gas supply line 31 and the oxidizing gas introduction line 32, the oxygen-containing air flows from the one side (oxidizing gas supply line 31 side) to the other side (oxidizing gas introduction line 32 side) of the oxidizing gas recirculation line 33. That is, a portion of the oxygen-containing air flowing through the oxidizing gas supply line 31 is recirculated to the oxidizing gas introduction line 32 via the oxidizing gas recirculation line 33.

### (Exhaust Discharge Line and Exhaust Flow Rate Adjusting Valve)

The fuel cell electric vehicle 1 further includes an exhaust discharge line 14 for discharging the exhaust gas (steam) generated by an electrochemical reaction between the fuel gas (hydrogen) and the oxidizing gas (oxygen) in the fuel cell 2 to the outside of the fuel cell electric vehicle 1, and an exhaust flow rate adjusting valve 15 configured to adjust the flow rate of the steam passing through the exhaust discharge line 14.

### (Measuring Devices Mounted in Fuel Cell Electric Vehicle)

The fuel cell electric vehicle 1 further includes an oxidizing gas pressure measuring device (for example, an air pressure sensor) 16 configured to measure an oxidizing gas pressure OP (air pressure), and a fuel gas pressure measuring device (for example, a hydrogen pressure sensor) 17 configured to measure a fuel gas pressure HP (hydrogen pressure). The oxidizing gas pressure measuring device 16 may measure the pressure of the air in the air electrode 21 of the fuel cell 2, as the oxidizing gas pressure OP, or may measure the pressure of the air flowing through the oxidizing gas supply line 31 (particularly, the downstream side of the branching portion 312). The fuel gas pressure measuring device 17 may measure the pressure of the hydrogen gas in the fuel electrode 22 of the fuel cell 2, as the fuel gas pressure HP, or may measure the pressure of the hydrogen gas flowing through the fuel gas supply line 42 (particularly, the downstream side of the fuel gas flow rate adjusting valve 43).

The fuel cell electric vehicle 1 may further include an oxidizing gas flow rate measuring device (for example, an air flow rate meter) 18 configured to measure an oxidizing gas flow rate (amount of the air supplied to the fuel cell 2) of the fuel cell 2. The oxidizing gas flow rate measuring device 18 may measure the flow rate of the air flowing through the oxidizing gas supply line 31 (particularly, the downstream side of the branching portion 312), as an oxidizing gas flow rate OF. When a control device 8 (to be described later) includes an oxidizing gas flow rate estimation unit 81 configured to estimate the oxidizing gas flow rate OF by using a known method from the oxidizing gas pressure OP or a rotation speed N of the compressor 7, the fuel cell electric vehicle 1 may not include the oxidizing gas flow rate measuring device 18.

### (Control Device)

The oxidizing gas supply system 3 further includes at least the control device 8 for controlling opening and closing of the oxidizing gas flow rate adjusting valve 34. In the illustrated embodiment, the control device 8 is an electronic control unit for adjusting the pressure or the flow rate of the oxidizing gas or of the fuel gas supplied to the fuel cell 2, and may be configured as a microcomputer including a CPU (processor) (not illustrated), a memory such as a ROM and a RAM, a storage device such as an external storage device, an I/O interface, and a communication interface. For example, each unit (to be described later) is realized by operating the CPU (for example, data calculation) in accordance with a command of a program loaded in a main storage device of the memory.

In the illustrated embodiment, each of the oxidizing gas flow rate adjusting valve 34, the fuel gas flow rate adjusting valve 43, and the exhaust flow rate adjusting valve 15 is connected to the control device 8 to be capable of telecommunication via wired or wireless communication. Each of the oxidizing gas flow rate adjusting valve 34, the fuel gas flow rate adjusting valve 43, and the exhaust flow rate adjusting valve 15 has an actuator (not illustrated) operated in accordance with an opening and closing indication transmitted from the control device 8, and is configured to control opening and closing (opening degree) in accordance with the opening and closing indication transmitted from the control device 8. Each of the oxidizing gas flow rate adjusting valve 34, the fuel gas flow rate adjusting valve 43, and the exhaust flow rate adjusting valve 15 may be an on/off valve whose opening degree can be adjusted to a fully closed state or a fully open state, or may be an opening degree adjusting valve which can adjust the opening degree to at least one intermediate opening degree between the fully closed state and the fully open state.

In the illustrated embodiment, the electric compressor 7A (compressor 7) is connected to the control device 8 to be capable of telecommunication via wired or wireless communication. The electric compressor 7A (compressor 7) is configured to control the rotation speed in accordance with a rotation speed indication transmitted from the control device 8.

Information relating to an operation of the fuel cell electric vehicle 1 is transmitted to the control device 8 from each device included in the fuel cell electric vehicle 1, such as the driving battery 5, the traveling motor 6, the oxidizing gas pressure measuring device 16, and the fuel gas pressure measuring device 17. The information relating to the operation of the fuel cell electric vehicle 1 includes a charge rate CR of the driving battery 5, power consumption PC of the traveling motor 6, a measurement value of the oxidizing gas pressure OP, a measurement value of the fuel gas pressure HP, and the rotation speed N of the compressor 7. The information relating to the operation of the fuel cell electric vehicle 1 is stored in a database unit 80.

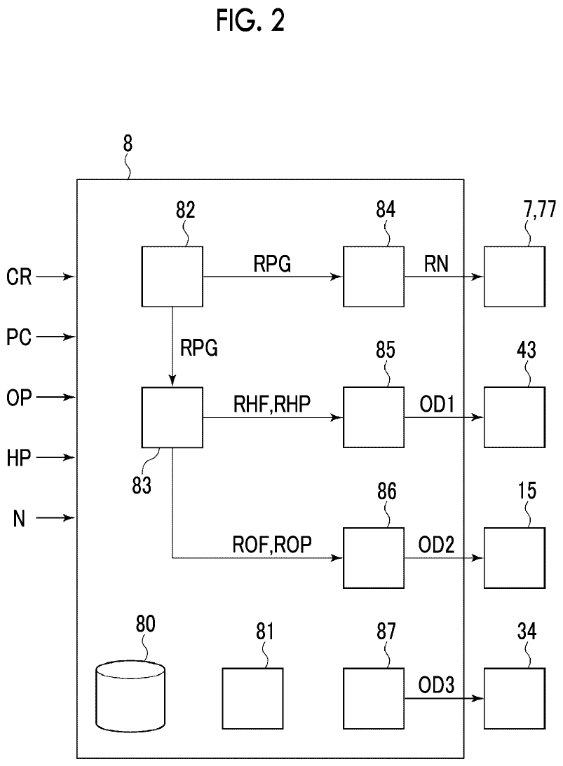

FIG. 2 is a view for describing a function of the control device 8 in the embodiment of the present disclosure. The control device 8 includes the database unit 80, a required power generation amount estimation unit 82 configured to estimate a power generation amount (required power generation amount RPG) required by the fuel cell electric vehicle 1, a required amount calculation unit 83 that calculates a required amount required for the fuel cell 2 to generate the required power generation amount RPG, a rotation speed indicating unit 84 that indicates the rotation speed of the compressor 7 to the compressor 7, a fuel gas side opening degree indicating unit 85 that indicates the opening degree to the fuel gas flow rate adjusting valve 43, an exhaust side opening degree indicating unit 86 that indicates the opening degree to the exhaust flow rate adjusting valve 15, and an oxidizing gas side opening degree indicating unit 87 that indicates the opening degree to the oxidizing gas flow rate adjusting valve 34. Each unit (required power generation amount estimation unit 82, required amount calculation unit 83, rotation speed indicating unit 84, fuel gas side opening degree indicating unit 85, exhaust side opening degree indicating unit 86, and oxidizing gas side opening degree indicating unit 87) of the control device 8 is configured to acquire required information from the database unit 80. As illustrated in FIG. 2, the control device 8 may further include the oxidizing gas flow rate estimation unit 81.

The power generation amount (required power generation amount RPG) required by the fuel cell electric vehicle 1 varies depending on each power generation aspect of the fuel cell 2. In a certain embodiment, the control device 8 adjusts the pressure or the flow rate of the oxidizing gas or of the fuel gas supplied to the fuel cell 2 so that the fuel cell 2 generates the electric power corresponding to the power consumption PC of the traveling motor 6. The required power generation amount estimation unit 82 may use the power generation amount corresponding to the power consumption PC of the traveling motor 6, as the required power generation amount RPG.

In the present embodiment, the required power generation amount estimation unit 82 may obtain the required power generation amount RPG from the power consumption PC of the traveling motor 6, based on first association information in which the power consumption PC of the traveling motor 6 and the required power generation amount RPG are associated with each other in advance. The first association information is information including a tendency that the required power generation amount RPG corresponding to the power consumption PC increases as the power consumption PC of the traveling motor 6 increases, and is stored in the database unit 80 in advance.

In a certain embodiment, the control device 8 adjusts the pressure or the flow rate of the oxidizing gas or of the fuel gas supplied to the fuel cell 2 so that the fuel cell 2 starts power generation, when the charge rate CR of the driving battery 5 is lower than a preset specified charge rate RC (specified value). The required power generation amount estimation unit 82 may set the required power generation amount RPG to zero, when the charge rate CR of the driving battery 5 is equal to or higher than the specified charge rate RC. In addition, the required power generation amount estimation unit 82 may set the required power generation amount RPG to a preset set value (constant power generation amount), or may set the required power generation amount RPG to the power generation amount corresponding to the charge rate CR of the driving battery 5, when the charge rate CR of the driving battery 5 is lower than the specified charge rate RC.

In the present embodiment, when the charge rate CR of the driving battery 5 is lower than the specified charge rate RC, the required power generation amount estimation unit 82 may obtain the required power generation amount RPG from the charge rate CR of the driving battery 5, based on second association information in which the charge rate CR of the driving battery 5 and the required power generation amount RPG are associated with each other in advance. The second association information is information including a tendency that the required power generation amount RPG corresponding to the charge rate CR increases as the charge rate CR of the driving battery 5 decreases, and is stored in the database unit 80 in advance.

The required amount calculation unit 83 calculates the required amount required for the fuel cell 2 to generate the required power generation amount RPG estimated by the required power generation amount estimation unit 82. The required amount includes a required oxidizing gas flow rate ROF which is a flow rate OF required for the oxidizing gas supplied to the air electrode 21 of the fuel cell 2, a required oxidizing gas pressure ROP which is a pressure OP required for the oxidizing gas supplied to the air electrode 21 of the fuel cell 2, a required fuel gas flow rate RHF which is a flow rate HF required for the fuel gas supplied to the fuel electrode 22 of the fuel cell 2, and a required fuel gas pressure RHP which is a fuel gas pressure HP required for the fuel gas supplied to the fuel electrode 22 of the fuel cell 2.

For example, the required amount calculation unit 83 may obtain each of the required oxidizing gas flow rate ROF, the required oxidizing gas pressure ROP, the required fuel gas flow rate RHF, and the required fuel gas pressure RHP from the required power generation amount RPG estimated by the required power generation amount estimation unit 82, based on third association information in which each of the required oxidizing gas flow rate ROF, the required oxidizing gas pressure ROP, the required fuel gas flow rate RHF, and the required fuel gas pressure RHP, and the required power generation amount RPG are associated with each other in advance. The third association information is stored in the database unit 80 in advance.

The rotation speed indicating unit 84 is configured to indicate a required rotation speed RN which is the rotation speed corresponding to the required power generation amount RPG estimated by the required power generation amount estimation unit 82, to the electric motor 77 of the compressor 7. For example, the rotation speed indicating unit 84 may obtain the required rotation speed RN from the required power generation amount RPG estimated by the required power generation amount estimation unit 82, based on fourth association information in which the required power generation amount RPG and the required rotation speed RN are associated with each other in advance. The fourth association information is information including a tendency that the required rotation speed RN corresponding to the required power generation amount RPG increases as the required power generation amount RPG increases, and is stored in the database unit 80 in advance.

The fuel gas side opening degree indicating unit 85 is configured to indicate the required fuel gas flow rate RHF calculated by the required amount calculation unit 83 and an indicated opening degree OD1 corresponding to the required fuel gas pressure RHP, to the fuel gas flow rate adjusting valve 43. For example, the fuel gas side opening degree indicating unit 85 may obtain the indicated opening degree OD1 from the required fuel gas flow rate RHF and the required fuel gas pressure RHP which are calculated by the required amount calculation unit 83, based on fifth association information in which the required fuel gas flow rate RHF, the required fuel gas pressure RHP, and the indicated opening degree OD1 are associated with each other in advance. The fifth association information is stored in the database unit 80 in advance.

The exhaust side opening degree indicating unit 86 is configured to indicate an indicated opening degree OD2 corresponding to the required oxidizing gas flow rate ROF and the required oxidizing gas pressure ROP which are calculated by the required amount calculation unit 83, to the exhaust flow rate adjusting valve 15. For example, the exhaust side opening degree indicating unit 86 may obtain the indicated opening degree OD2 from the required oxidizing gas flow rate ROF and the required oxidizing gas pressure ROP which are calculated by the required amount calculation unit 83, based on sixth association information in which the required oxidizing gas flow rate ROF, the required oxidizing gas pressure ROP, and the indicated opening degree OD2 are associated with each other in advance. The sixth association information is stored in the database unit 80 in advance.

When a difference (differential pressure) between the measurement value of the oxidizing gas pressure OP and the measurement value of the fuel gas pressure HP exceeds an allowable value, there is a possibility that the electrolyte film 23 will be damaged. When the differential pressure exceeds the allowable value, at least one of the rotation speed indicating unit 84, the fuel gas side opening degree indicating unit 85, or the exhaust side opening degree indicating unit 86 may adjust at least one of the required rotation speed RN, the indicated opening degree OD1 or the indicated opening degree OD2 so that the differential pressure is equal to or smaller than the allowable value.

When the opening degree of the exhaust flow rate adjusting valve 15 decreases in accordance with the indicated opening degree OD2, the discharge amount of the exhaust gas (steam) discharged from the fuel cell 2 decreases. Therefore, the pressure of the oxidizing gas inside the fuel cell 2 increases, and the pressure (oxidizing gas pressure OP) of the oxidizing gas supplied to the air electrode 21 of the fuel cell 2 increases. In addition, when the opening degree of the exhaust flow rate adjusting valve 15 decreases in accordance with the indicated opening degree OD2, the discharge amount of the exhaust gas (steam) discharged from the fuel cell 2 decreases. Therefore, the flow rate (oxidizing gas flow rate OF) of the oxidizing gas which can be supplied to the air electrode 21 of the fuel cell 2 decreases. When the flow rate of the oxidizing gas (oxidizing gas flow rate OF) which can be supplied to the air electrode 21 of the fuel cell 2 decreases, the flow rate of the oxidizing gas which can be supplied to the compressor impeller 71 also decreases. Therefore, there is an increasing probability that surging will occur in the compressor 7.

The oxidizing gas side opening degree indicating unit 87 is configured to indicate an indicated opening degree OD3 to the oxidizing gas flow rate adjusting valve 34. As will be described in detail later, when there is a high probability that surging will occur in the compressor 7, the oxidizing gas side opening degree indicating unit 87 raises the indicated opening degree OD3, and raises the opening degree of the oxidizing gas flow rate adjusting valve 34. In addition, when there is a low probability that surging will occur in the compressor 7, the oxidizing gas side opening degree indicating unit 87 lowers the indicated opening degree OD3, and lowers the opening degree of the oxidizing gas flow rate adjusting valve 34. In the present disclosure, description of “raising (increasing) the opening degree” includes changing the opening degree from the fully closed state to the intermediate opening degree or the fully open state. In the present disclosure, description of “lowering (decreasing) the opening degree” includes changing the opening degree from the fully open state or the intermediate opening degree to the fully closed state.

As illustrated in FIG. 1, the oxidizing gas supply system 3 according to some embodiments includes the compressor 7, the oxidizing gas supply line 31, the oxidizing gas introduction line 32, the oxidizing gas recirculation line 33, and the oxidizing gas flow rate adjusting valve 34.

According to the above-described configuration, when the required oxidizing gas flow rate ROF of the fuel cell 2 decreases and the oxidizing gas flow rate OF which can be supplied to the fuel cell 2 via the oxidizing gas supply line 31 decreases, the oxidizing gas flow rate adjusting valve 34 is opened so that a portion of the oxidizing gas can be recirculated from the oxidizing gas supply line 31 to the oxidizing gas introduction line 32 via the oxidizing gas recirculation line 33. In this manner, the amount of the oxidizing gas flowing into the compressor impeller 71 when the required oxidizing gas flow rate ROF of the fuel cell 2 decreases can be increased. Therefore, surging in the compressor 7 can be suppressed without lowering the rotation speed of the compressor 7.

In addition, according to the above-described configuration, when the required oxidizing gas flow rate ROF of the fuel cell 2 increases and the oxidizing gas flow rate OF which can be supplied to the fuel cell 2 via the oxidizing gas supply line 31 increases, the oxidizing gas flow rate adjusting valve 34 is closed, and recirculation of the oxidizing gas via the oxidizing gas recirculation line 33 is suppressed. In this manner, it is possible to suppress a decrease in efficiency of the compressor 7 which is caused by the recirculation of the oxidizing gas.

When the oxidizing gas supply system 3 is configured to expose the oxidizing gas existing in the oxidizing gas supply line 31 to the atmosphere, most of the oxidizing gas passing through the compressor impeller 71 is discarded to the atmosphere due to exposure to the atmosphere. Therefore, there is a possibility that power will not be generated without causing a sufficient amount of the oxidizing gas to flow through the power generation cell 20. According to the above-described configuration, a portion of the oxidizing gas existing in the oxidizing gas supply line 31 is recirculated via the oxidizing gas recirculation line 33, and a remaining portion of the oxidizing gas existing in the oxidizing gas supply line 31 is supplied to the power generation cell 20. In this manner, since the sufficient amount of the oxidizing gas is supplied to the power generation cell 20, the power can be generated.

In addition, according to the above-described configuration, a portion of the oxidizing gas existing in the oxidizing gas supply line 31 is recirculated via the oxidizing gas recirculation line 33. In this manner, compared to when the oxidizing gas is not recirculated, the pressure and the temperature of the oxidizing gas supplied to the compressor impeller 71 can be increased, and the power of the compressor 7 can be increased. Since a load on the compressor 7 is increased by increasing the power of the compressor 7, the rotation speed of the compressor impeller 71 can be quickly lowered. When the compressor 7 is urgently stopped due to an abnormality occurrence such as surging and asynchronous vibration, damage to the compressor 7 can be suppressed by quickly lowering the rotation speed of the compressor impeller 71.

### (First Opening Degree Increasing Control)

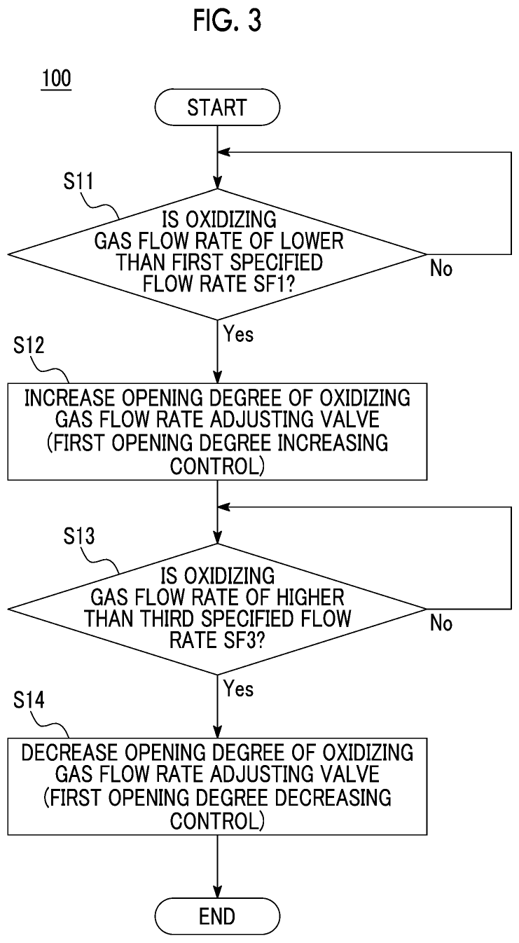

FIG. 3 is a flowchart illustrating an example of control 100 including first opening degree increasing control of the control device 8 according to the embodiment of the present disclosure. In some embodiments, as illustrated in FIG. 3, the control device 8 is configured to perform the first opening degree increasing control (S12) for increasing the opening degree of the oxidizing gas flow rate adjusting valve 34, when the flow rate (in the illustrated example, a measurement value of the oxidizing gas flow rate OF) of the oxidizing gas supplied to the fuel cell 2 is lower than a preset first specified flow rate SF1 (in a case of “Yes” in S11). In the illustrated embodiment, the oxidizing gas side opening degree indicating unit 87 is configured to perform the first opening degree increasing control. Here, description of “the flow rate of the oxidizing gas supplied to the fuel cell 2 is lower than the first specified flow rate SF1” means that a state where the flow rate of the oxidizing gas supplied to the fuel cell 2 is higher than the first specified flow rate SF1 is shifted to a state where the flow rate of the oxidizing gas supplied to the fuel cell 2 is lower than the first specified flow rate SF1.

According to the above-described configuration, when the flow rate (in the illustrated example, a measurement value of the oxidizing gas flow rate OF) of the oxidizing gas supplied to the fuel cell 2 is lower than the first specified flow rate SF1, the flow rate of the oxidizing gas introduced into the compressor impeller 71 via the oxidizing gas introduction line 32 decreases, thereby resulting in a high probability that surging will occur in the compressor 7. When the flow rate of the oxidizing gas supplied to the fuel cell 2 is lower than the first specified flow rate SF1, the control device 8 performs the first opening degree increasing control, and increases the opening degree of the oxidizing gas flow rate adjusting valve 34. In this manner, a recirculation amount of the oxidizing gas via the oxidizing gas recirculation line 33 can be increased. The amount of the oxidizing gas flowing into the compressor impeller 71 can be increased by increasing the recirculation amount of the oxidizing gas via the oxidizing gas recirculation line 33. Therefore, surging in the compressor 7 can be effectively suppressed.

### (First Opening Degree Decreasing Control)

In some embodiments, as illustrated in FIG. 3, the control device 8 may be configured to perform first opening degree decreasing control (S14) for decreasing the opening degree of the oxidizing gas flow rate adjusting valve 34, when the flow rate (in the illustrated example, a measurement value of the oxidizing gas flow rate OF) of the oxidizing gas supplied to the fuel cell 2 is higher than a preset third specified flow rate SF3 (in a case of “Yes” in S13). As illustrated in FIG. 3, the first opening degree decreasing control may be performed after the first opening degree increasing control is performed. In the first opening degree decreasing control, the opening degree of the oxidizing gas flow rate adjusting valve 34 which is increased in the first opening degree increasing control may be recirculated to the opening degree before the opening degree is increased in the first opening degree increasing control. In the illustrated embodiment, the oxidizing gas side opening degree indicating unit 87 is configured to perform the first opening degree decreasing control. The third specified flow rate SF3 is higher than the first specified flow rate SF1. Here, description of “the flow rate of the oxidizing gas supplied to the fuel cell 2 exceeds the third specified flow rate SF3” means that a state where the flow rate of the oxidizing gas supplied to the fuel cell 2 is lower than the third specified flow rate SF3 is shifted to a state where the flow rate of the oxidizing gas supplied to the fuel cell 2 is higher than the third specified flow rate SF3.

### (Rapid Opening Degree Increasing Control)

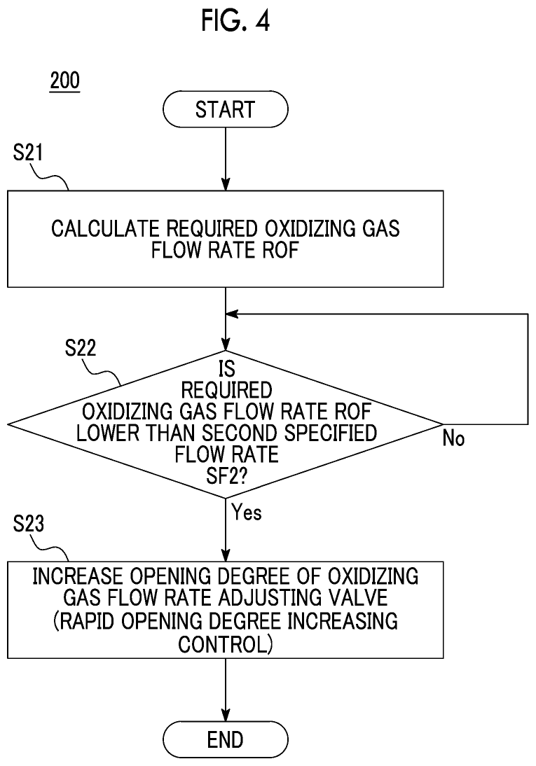

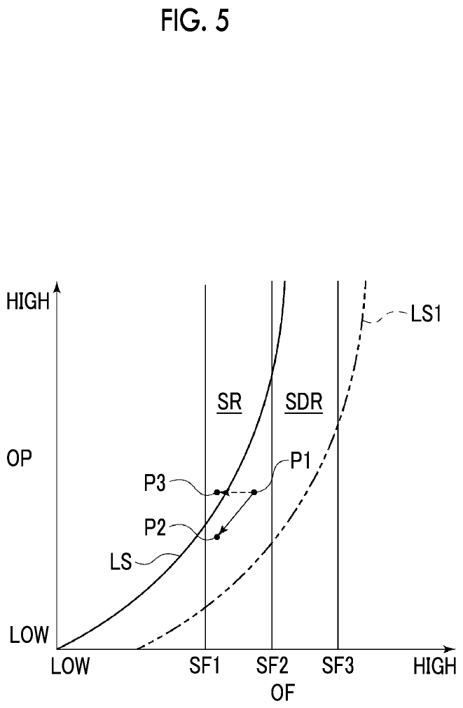

FIG. 4 is a flowchart illustrating an example of control 200 including rapid opening degree increasing control of the control device 8 according to the embodiment of the present disclosure. FIG. 5 is a view for describing a change in an operating point of the compressor 7 when the flow rate of the oxidizing gas supplied to the fuel cell 2 is changed to a low flow rate.

In some embodiments, as illustrated in FIG. 4, the control device 8 is configured to perform the rapid opening degree increasing control (S23) for increasing the opening degree of the oxidizing gas flow rate adjusting valve 34, when the required oxidizing gas flow rate ROF of the fuel cell 2 is lower than a second specified flow rate SF2 (in a case of “Yes” in S22). In the illustrated embodiment, the required amount calculation unit 83 calculates the required oxidizing gas flow rate ROF (S21), and the oxidizing gas side opening degree indicating unit 87 performs the rapid opening degree increasing control. Here, description of “the required oxidizing gas flow rate ROF is lower than the second specified flow rate SF2” means that a state where the required oxidizing gas flow rate ROF is higher than the second specified flow rate SF2 is shifted to a state where the required oxidizing gas flow rate ROF is lower than the second specified flow rate SF2.

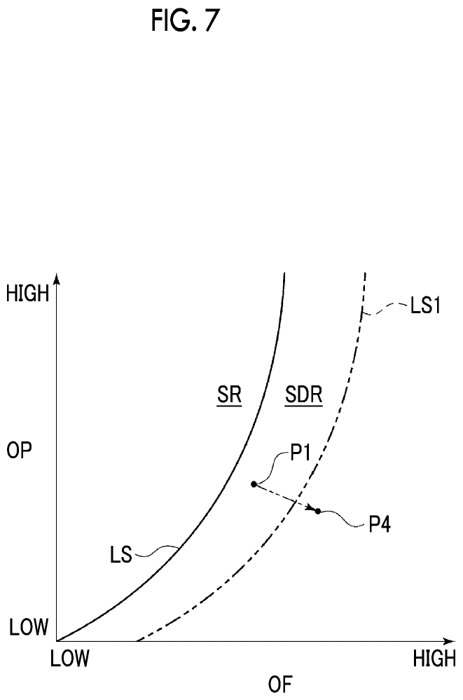

FIGS. 5 and 7 (to be described later) illustrate a compressor map in which the oxidizing gas flow rate OF is set as a horizontal axis and the oxidizing gas pressure OP is set as a vertical axis. The compressor map indicates a surge line LS of the compressor 7, a surge region SR formed on a lower flow rate side than the surge line LS, a surge danger operation region SDR provided in the vicinity of the surge region SR on a side (high flow rate side) opposite to the surge region SR across the surge line LS, and P1 which is a current operating point (working point) P of the compressor 7. As illustrated in FIGS. 5 and 7, the surge danger operation region SDR may be formed between a surge danger line LS1 formed in a curved shape along the surge line LS on the high flow rate side of the surge line LS in the compressor map and a surge line LS. Each of the surge line LS, the surge danger line LS1, the surge region SR, and the surge danger operation region SDR is preset and stored in the database unit 80.

As illustrated in FIG. 5, when the flow rate OF of the oxidizing gas supplied to the fuel cell 2 is changed from the high flow rate to the low flow rate (when the operating point P of the compressor 7 is shifted from P1 to P2), as indicated by a dotted line in FIG. 5, the flow rate is changed before the pressure is changed, and the operating point P (P3) of the compressor 7 temporarily enters the surge region SR, thereby resulting in a possibility that surging will occur in the compressor 7.

According to the above-described configuration, when the required oxidizing gas flow rate ROF of the fuel cell 2 is lower than the second specified flow rate SF2, thereafter, the flow rate OF of the oxidizing gas supplied to the fuel cell 2 decreases, thereby resulting in a high probability that the operating point of the compressor 7 will temporarily enter the surge region SR. When the required oxidizing gas flow rate ROF of the fuel cell 2 is lower than the second specified flow rate SF2, the control device 8 performs the rapid opening degree increasing control, and increases the opening degree of the oxidizing gas flow rate adjusting valve 34. In this manner, thereafter, when the flow rate OF of the oxidizing gas supplied to the fuel cell 2 decreases since the required oxidizing gas flow rate ROF is lowered thereafter, it is possible to reduce a probability that the operating point of the compressor 7 will temporarily enter the surge region SR. Therefore, surging in the compressor 7 can be effectively suppressed.

In some embodiments, as illustrated in FIG. 5, the second specified flow rate SF2 is higher than the first specified flow rate SF1. According to the above-described configuration, since the second specified flow rate SF2 is increased than the first specified flow rate SF1, when the flow rate OF of the oxidizing gas supplied to the fuel cell 2 is changed from the high flow rate to the low flow rate, it is possible to effectively reduce a probability that the operating point of the compressor 7 will temporarily enter the surge region SR. In addition, according to the above-described configuration, since the first specified flow rate SF1 is decreased than the second specified flow rate SF2, it is possible to reduce the frequency of the first opening degree increasing control performed by the control device 8. Therefore, a pressure loss (energy loss) of the oxidizing gas recirculated via the oxidizing gas recirculation line 33 can be suppressed. A decrease in the efficiency of the compressor 7 can be suppressed by suppressing the pressure loss of the oxidizing gas.

### (Second Opening Degree Increasing Control)

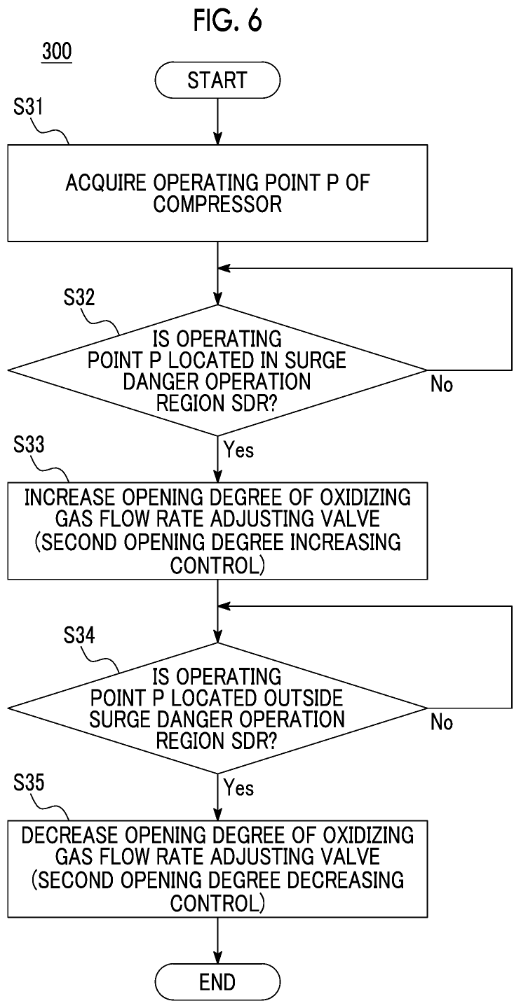

FIG. 6 is a flowchart illustrating an example of control 300 including second opening degree increasing control of the control device 8 according to the embodiment of the present disclosure. FIG. 7 is a view for describing the second opening degree increasing control and second opening degree decreasing control. In some embodiments, as illustrated in FIG. 6, the control device 8 is configured to perform the second opening degree increasing control (S33) for increasing the opening degree of the oxidizing gas flow rate adjusting valve 34, when the operating point P (P1, refer to FIG. 7) of the compressor 7 corresponding to the flow rate (in the illustrated example, a measurement value or an estimation value of the oxidizing gas flow rate OF) of the oxidizing gas supplied to the fuel cell 2 and the pressure (in the illustrated example, a measurement value of the oxidizing gas pressure OP) of the oxidizing gas supplied to the fuel cell 2 is located in the preset surge danger operation region SDR (in a case of “Yes” in S32). In the illustrated embodiment, the oxidizing gas side opening degree indicating unit 87 (control device 8) is configured to acquire the operating point P (S31) and to perform the second opening degree increasing control (S32 and S33).

The oxidizing gas side opening degree indicating unit 87 (control device 8) is configured to acquire the operating point P of the compressor 7 corresponding to either the measurement value or the estimation value of the oxidizing gas flow rate OF, and the measurement value of the oxidizing gas pressure OP. For example, the oxidizing gas side opening degree indicating unit 87 (control device 8) may obtain either the measurement value or the estimation value of the oxidizing gas flow rate OF, and the measurement value of the oxidizing gas s pressure OP, from either the measurement value or the estimation value of the oxidizing gas flow rate OF, and the measurement value of the oxidizing gas pressure OP, based on seventh association information in which the oxidizing gas flow rate OF, the oxidizing gas pressure OP, and the operating point P of the compressor 7 are associated with each other in advance. The seventh association information is stored in the database unit 80 in advance.

According to the above-described configuration, when the operating point P (P1) of the compressor 7 corresponding to the flow rate of the oxidizing gas supplied to the fuel cell 2 and the pressure of the oxidizing gas is located in the surge danger operation region SDR, thereafter, there is a high probability that the operating point P of the compressor 7 will enter the surge region SR. When the operating point P of the compressor 7 is located in the surge danger operation region SDR, the control device 8 performs the second opening degree increasing control, and increases the opening degree of the oxidizing gas flow rate adjusting valve 34. In this manner, surging in the compressor 7 can be prevented. In this manner, surging in the compressor 7 can be effectively suppressed.

### (Second Opening Degree Decreasing Control)

In some embodiments, as illustrated in FIG. 6, the control device 8 may be configured to perform second opening degree decreasing control (S35) for decreasing the opening degree of the oxidizing gas flow rate adjusting valve 34, when the operating point P (P4, refer to FIG. 7) of the compressor 7 is located outside the surge danger operation region SDR (high flow rate side of the surge danger line LS1) after the second opening degree increasing control is performed (in a case of “Yes” in S34). In the second opening degree decreasing control, the opening degree of the oxidizing gas flow rate adjusting valve 34 which is increased in the second opening degree increasing control may be returned to the opening degree before the opening degree is increased in the second opening degree increasing control. In the illustrated embodiment, the oxidizing gas side opening degree indicating unit 87 is configured to perform the second opening degree decreasing control.

In some embodiments, as illustrated in FIG. 1, the oxidizing gas recirculation line 33 is provided inside the compressor cover 72. The branching portion 312 to which one side of the oxidizing gas recirculation line 33 is connected is provided in the oxidizing gas discharge path 76, and the merging portion 322 to which the other side of the oxidizing gas recirculation line 33 is connected is provided in the oxidizing gas introduction path 75.

According to the above-described configuration, since the oxidizing gas recirculation line 33 is provided inside the compressor cover 72, compared to when the oxidizing gas recirculation line 33 is provided outside the compressor cover 72, it is possible to shorten a length from one end which is a connecting portion to the branching portion 312 of the oxidizing gas recirculation line 33 to the other end which is a connecting portion to the merging portion 322. Therefore, a pressure loss (energy loss) of the oxidizing gas recirculated via the oxidizing gas recirculation line 33 can be suppressed. A decrease in the efficiency of the compressor 7 can be suppressed by suppressing the pressure loss of the oxidizing gas. In addition, since the length from one end to the other end of the oxidizing gas recirculation line 33 is shortened, responsiveness is improved when the opening degree of the oxidizing gas flow rate adjusting valve 34 is increased or decreased, and the recirculation amount of the oxidizing gas via the oxidizing gas recirculation line 33 can be quickly increased or decreased.

### (Heat Exchanger)

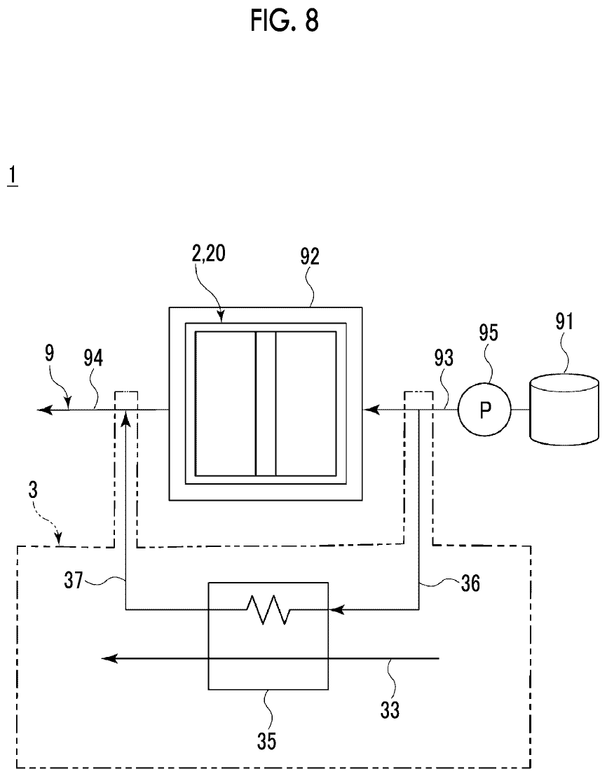

FIG. 8 is a view for describing a heat exchanger of the oxidizing gas supply system according to the embodiment of the present disclosure. In some embodiments, as illustrated in FIG. 8, the oxidizing gas supply system 3 further includes a heat exchanger (oxidizing gas side heat exchanger) 35 provided in the oxidizing gas recirculation line 33 and configured to exchange heat between the oxidizing gas flowing through the oxidizing gas recirculation line 33 and a refrigerant. The refrigerant has a lower temperature than the oxidizing gas flowing through the oxidizing gas recirculation line 33, and in the heat exchanger 35, heat energy is transmitted to the refrigerant from the oxidizing gas flowing through the oxidizing gas recirculation line 33. In this manner, the oxidizing gas flowing through the oxidizing gas recirculation line 33 is cooled.

The oxidizing gas compressed by the compressor impeller 71 and flowing through the oxidizing gas supply line 31 has a higher temperature than the oxidizing gas introduced into the compressor impeller 71 via the oxidizing gas introduction line 32. According to the above-described configuration, the oxidizing gas flowing through the oxidizing gas recirculation line 33 is cooled by the heat exchanger 35 provided in the oxidizing gas recirculation line 33. Therefore, it is possible to suppress an increase in the temperature of the oxidizing gas introduced into the compressor impeller 71, which is caused by recirculation of the oxidizing gas via the oxidizing gas recirculation line 33. The power (energy consumption) of the compressor 7 can be reduced by suppressing the increase in the temperature of the oxidizing gas introduced into the compressor impeller 71.

In some embodiments, the refrigerant for cooling the oxidizing gas flowing through the oxidizing gas recirculation line 33 in the heat exchanger 35 is made of a heat medium having the same type as the refrigerant for cooling the fuel cell 2. The fuel cell electric vehicle 1 further includes a cooling system 9 for cooling the fuel cell 2. The cooling system 9 includes a refrigerant storage device (for example, a cooling water tank) 91 configured to store the refrigerant (for example, cooling water), a fuel cell side heat exchanger 92 configured to exchange the heat between the fuel cell 2 and the refrigerant, a refrigerant supply line 93 for guiding the refrigerant from the refrigerant storage device 91 to the fuel cell side heat exchanger 92, a refrigerant discharge line 94 for discharging the refrigerant subjected to heat exchange in the fuel cell side heat exchanger 92, and a refrigerant pump 95 provided in either the refrigerant supply line 93 or the refrigerant discharge line 94.

In the illustrated embodiment, the oxidizing gas supply system 3 further includes a first refrigerant diversion line 36 for guiding the refrigerant to the heat exchanger 35 from either the refrigerant supply line 93 or the refrigerant discharge line 94, and a second refrigerant diversion line 37 for discharging the refrigerant from the heat exchanger 35 to either the refrigerant supply line 93 or the refrigerant discharge line 94. In another embodiment, the flow path through which the refrigerant flows in the heat exchanger 35 may be provided in either the refrigerant supply line 93 or the refrigerant discharge line 94.

According to the above-described configuration, devices or pipes of the cooling system 9 can be used to feed the refrigerant to the heat exchanger 35, and the refrigerant storage device 91 or the refrigerant pump 95 may not be separately provided for the heat exchanger 35. Therefore, it is possible to avoid a complicated or expensive configuration of the oxidizing gas supply system 3 including the heat exchanger 35.

As illustrated in FIG. 1, the fuel cell electric vehicle 1 according to some embodiments includes the oxidizing gas supply system 3, and is configured to travel by using the electric power generated by the fuel cell 2. According to the above-described configuration, since the fuel cell electric vehicle 1 includes the oxidizing gas supply system 3, surging in the compressor 7 can be suppressed. Therefore, efficiency of the fuel cell electric vehicle 1 can be improved.

The present disclosure is not limited to the above-described embodiments, and also includes a form in which modifications are added to the above-described embodiments or a form in which the embodiments are combined with each other as appropriate.

The contents described in some of the above-described embodiments are understood as follows, for example.

1) According to at least one embodiment of the present disclosure, there is provided the oxidizing gas supply system (3) for supplying the oxidizing gas compressed by the compressor (7) to the fuel cell (2).

The oxidizing gas supply system (3) includes the compressor (7) including the compressor impeller (71), the oxidizing gas supply line (31) for supplying the oxidizing gas passing through the compressor impeller (71) to the fuel cell (2), the oxidizing gas introduction line (32) for introducing the oxidizing gas into the compressor impeller (71), the oxidizing gas recirculation line (33 branching from the oxidizing gas supply line (31) and connected to the oxidizing gas introduction line (32), and the flow rate adjusting valve (oxidizing gas flow rate adjusting valve 34) configured to adjust the flow rate of the oxidizing gas passing through the oxidizing gas recirculation line (33).

According to the configuration of 1) above, when the required oxidizing gas flow rate of the fuel cell (2) decreases and the flow rate of the oxidizing gas which can be supplied to the fuel cell (2) via the oxidizing gas supply line (31) decreases, the flow rate adjusting valve (34) is opened, and a portion of the oxidizing gas can be recirculated from the oxidizing gas supply line (31) to the oxidizing gas introduction line (32) via the oxidizing gas recirculation line (33). In this manner, the amount of the oxidizing gas flowing into the compressor impeller (71) when the required oxidizing gas flow rate of the fuel cell (2) decreases can be increased. Therefore, surging in the compressor (7) can be suppressed.

In addition, according to the configuration of 1) above, when the required oxidizing gas flow rate of the fuel cell (2) increases and the flow rate of the oxidizing gas which can be supplied to the fuel cell (2) via the oxidizing gas supply line (31) increases, the flow rate adjusting valve (34) is closed to suppress the recirculation of the oxidizing gas via the oxidizing gas recirculation line (33). In this manner, it is possible to suppress a decrease in efficiency of the compressor (7) which is caused by the recirculation of the oxidizing gas.

2) In some embodiments, the oxidizing gas supply system (3) according to 1) above further includes the control device (8) for controlling opening and closing of the flow rate adjusting valve (34).

When the flow rate of the oxidizing gas supplied to the fuel cell (2) is lower than the first specified flow rate (SF1), the control device (8) is configured to perform the first opening degree increasing control for increasing the opening degree of the flow rate adjusting valve (34).

According to the configuration of 2) above, when the flow rate of the oxidizing gas supplied to the fuel cell (2) is lower than the first specified flow rate (SF1), the flow rate of the oxidizing gas introduced into the compressor impeller (71) via the oxidizing gas introduction line (32) decreases, thereby resulting in a high probability that surging will occur in the compressor (7). When the flow rate of the oxidizing gas supplied to the fuel cell (2) is lower than the first specified flow rate (SF1), the control device (8) performs the first opening degree increasing control, and increases the opening degree of the flow rate adjusting valve (34). In this manner, the recirculation amount of the oxidizing gas via the oxidizing gas recirculation line (33) can be increased. The amount of the oxidizing gas flowing into the compressor impeller (71) can be increased by increasing the recirculation amount of the oxidizing gas via the oxidizing gas recirculation line (33). Therefore, surging in the compressor (7) can be effectively suppressed.

3) In some embodiments, in the oxidizing gas supply system (3) according to 2) above, when the required oxidizing gas flow rate of the fuel cell (2) is lower than the second specified flow rate (SF2), the control device (8) is configured to perform the rapid opening degree increasing control for increasing the opening degree of the flow rate adjusting valve (34).

When the flow rate of the oxidizing gas supplied to the fuel cell (2) is changed from the high flow rate to the low flow rate, the flow rate is changed before the pressure is changed, and the operating point of the compressor (7) temporarily enters the surge region (SR), thereby resulting in a possibility that surging will occur in the compressor (7). According to the configuration of 3) above, when the required oxidizing gas flow rate of the fuel cell (2) is lower than the second specified flow rate (SF2), thereafter, the flow rate of the oxidizing gas supplied to the fuel cell (2) decreases, thereby resulting in a high probability that the operating point of the compressor (7) will temporarily enter the surge region (SR). When the required oxidizing gas flow rate of the fuel cell (2) is lower than the second specified flow rate (SF2), the control device (8) performs the rapid opening degree increasing control, and increases the opening degree of the flow rate adjusting valve (34). In this manner, thereafter, when the flow rate of the oxidizing gas supplied to the fuel cell (2) decreases, it is possible to reduce a probability that the operating point of the compressor (7) will temporarily enter the surge region (SR). Therefore, surging in the compressor (7) can be effectively suppressed.

4) In some embodiments, in the oxidizing gas supply system (3) according to 3) above, the second specified flow rate (SF2) is higher than the first specified flow rate (SF1).

According to the configuration of 4) above, since the second specified flow rate (SF2) is increased the first specified flow rate (SF1), when the flow rate of the oxidizing gas supplied to the fuel cell (2) is changed from the high flow rate to the low flow rate, it is possible to effectively reduce a probability that the operating point of the compressor (7) will temporarily enter the surge region (SR). In addition, according to the configuration of 4) above, since the first specified flow rate (SF1) is decreased than the second specified flow rate (SF2), it is possible to reduce the frequency of the first opening degree increasing control performed by the control device (8). Therefore, a pressure loss (energy loss) of the oxidizing gas recirculated via the oxidizing gas recirculation line (33) can be suppressed. Since the pressure loss of the oxidizing gas is suppressed, it is possible to suppress a decrease in efficiency of the compressor (7).

5) In some embodiments, the oxidizing gas supply system (3) according to 1) above further includes the control device (8) for controlling opening and closing of the flow rate adjusting valve (34).

The control device (8) is configured to perform the second opening degree increasing control for increasing the opening degree of the flow rate adjusting valve (34), when the operating point of the compressor (7) corresponding to the flow rate of the oxidizing gas supplied to the fuel cell (2) and the pressure of the oxidizing gas is located in the surge danger operation region (SDR).

According to the configuration of 5) above, when the operating point of the compressor (7) corresponding to the flow rate of the oxidizing gas supplied to the fuel cell (2) and the pressure of the oxidizing gas is located in the surge danger operation region (SDR), thereafter, there is a high probability that the operating point of the compressor (7) will enter the surge region (SR). When the operating point of the compressor (7) is located in the surge danger operation region (SDR), the control device (8) performs the second opening degree increasing control, and increases the opening degree of the flow rate adjusting valve (34). In this manner, surging in the compressor (7) can be prevented. In this manner, surging in the compressor (7) can be effectively suppressed.

6) In some embodiments, in the oxidizing gas supply system (3) according to any one of 1) to 5) above, the compressor (7) further includes the compressor cover (72) that rotatably accommodates the compressor impeller (71). The oxidizing gas recirculation line (33) is provided inside the compressor cover (72).

According to the configuration of 6) above, the oxidizing gas recirculation line (33) is provided inside the compressor cover (72). In this manner compared to when the oxidizing gas recirculation line (33) is provided outside the compressor cover (72), the length from one end to the other end of the oxidizing gas recirculation line (33) can be shortened. Therefore, a pressure loss (energy loss) of the oxidizing gas recirculated via the oxidizing gas recirculation line (33) can be suppressed. Since the pressure loss of the oxidizing gas is suppressed, it is possible to suppress a decrease in efficiency of the compressor (7).

7) In some embodiments, the oxidizing gas supply system (3) according to any one of 1) to 6) above further includes the heat exchanger (35) provided in the oxidizing gas recirculation line (33) and configured to exchange the heat between the oxidizing gas flowing through the oxidizing gas recirculation line (33) and the refrigerant.

The oxidizing gas compressed by the compressor impeller (71) and flowing through the oxidizing gas supply line (31) has a higher temperature than that of the oxidizing gas introduced into the compressor impeller (71) via the oxidizing gas introduction line (32). According to the configuration of 7) above, the oxidizing gas flowing through the oxidizing gas recirculation line (33) is cooled by the heat exchanger (35) provided in the oxidizing gas recirculation line (33). Therefore, it is possible to suppress an increase in the temperature of the oxidizing gas introduced into the compressor impeller (71) which is caused by the recirculation of the oxidizing gas via the oxidizing gas recirculation line (33). Since the increase in the temperature of the oxidizing gas introduced into the compressor impeller (71) is suppressed, the power (energy consumption) of the compressor (7) can be reduced.

8) The fuel cell electric vehicle (1) according to at least one embodiment of the present disclosure includes the oxidizing gas supply system (3) according to any one of 1) to 7) above.

The fuel cell electric vehicle (1) is configured to travel by using the electric power generated by the fuel cell (2).

According to the configuration of 8) above, since the fuel cell electric vehicle (1) includes the oxidizing gas supply system (3), surging in the compressor (7) can be suppressed. Therefore, efficiency of the fuel cell electric vehicle (1) can be improved.

### REFERENCE SIGNS LIST

1: Fuel cell electric vehicle
2: Fuel cell
3: Oxidizing gas supply system
4: Fuel gas supply system
5: Driving battery
6: Traveling motor
7: Compressor
8: Control device
9: Cooling system
11: First connection cable
12: Second connection cable
13: Vehicle body
14: Exhaust discharge line
15: Exhaust flow rate adjusting valve
16: Oxidizing gas pressure measuring device
17: Fuel gas pressure measuring device
18: Oxidizing gas flow rate measuring device
20: Power generation cell
21: Air electrode
22: Fuel electrode
23: Electrolyte film
31: Oxidizing gas supply line
32: Oxidizing gas introduction line
33: Oxidizing gas recirculation line
34: Oxidizing gas flow rate adjusting valve
35: Heat exchanger
36: First refrigerant diversion line
37: Second refrigerant diversion line
41: Fuel gas storage device
42: Fuel gas supply line
43: Fuel gas flow rate adjusting valve
71: Compressor impeller
72: Compressor cover
73: Introduction port
74: Discharge port
75: Oxidizing gas introduction path
76: Oxidizing gas discharge path
77: Electric motor
78: Rotary shaft
80: Database unit
81: Oxidizing gas flow rate estimation unit
82: Required power generation amount estimation unit
83: Required amount calculation unit
84: Rotation speed indicating unit
85: Fuel gas side opening degree indicating unit
86: Exhaust side opening degree indicating unit
87: Oxidizing gas side opening degree indicating unit
91: Refrigerant storage device
92: Fuel cell side heat exchanger
93: Refrigerant supply line
94: Refrigerant discharge line
95: Refrigerant pump

1. An oxidizing gas supply system for supplying an oxidizing gas compressed by a compressor to a fuel cell, comprising:
a compressor including a compressor impeller;
an oxidizing gas supply line for supplying the oxidizing gas passing through the compressor impeller to the fuel cell;
an oxidizing gas introduction line for introducing the oxidizing gas into the compressor impeller;
an oxidizing gas recirculation line branching from the oxidizing gas supply line and connected to the oxidizing gas introduction line; and
a flow rate adjusting valve configured to adjust a flow rate of the oxidizing gas passing through the oxidizing gas recirculation line.

2. The oxidizing gas supply system according to claim 1, further comprising:
a control device for controlling opening and closing of the flow rate adjusting valve,
wherein when the flow rate of the oxidizing gas supplied to the fuel cell is lower than a first specified flow rate, the control device is configured to perform first opening degree increasing control for increasing an opening degree of the flow rate adjusting valve.

3. The oxidizing gas supply system according to claim 2,
wherein when a required oxidizing gas flow rate of the fuel cell is lower than a second specified flow rate, the control device is configured to perform rapid opening degree increasing control for increasing the opening degree of the flow rate adjusting valve.

4. The oxidizing gas supply system according to claim 3,
wherein the second specified flow rate is higher than the first specified flow rate.

5. The oxidizing gas supply system according to claim 1, further comprising:
a control device for controlling opening and closing of the flow rate adjusting valve,
wherein when an operating point of the compressor corresponding to the flow rate of the oxidizing gas supplied to the fuel cell and a pressure of the oxidizing gas is located in a surge danger operation region, the control device is configured to perform second opening degree increasing control for increasing an opening degree of the flow rate adjusting valve.

6. The oxidizing gas supply system according to claim 1,
wherein the compressor further includes a compressor cover that rotatably accommodates the compressor impeller, and
the oxidizing gas recirculation line is provided inside the compressor cover.

7. The oxidizing gas supply system according to claim 1, further comprising:
a heat exchanger provided in the oxidizing gas recirculation line and configured to exchange heat between the oxidizing gas flowing through the oxidizing gas recirculation line and a refrigerant.

8. A fuel cell electric vehicle comprising:
the oxidizing gas supply system according to claim 1,
wherein the fuel cell electric vehicle is configured to travel by using electric power generated by the fuel cell.
